(19) United States
(12) Patent Application Publication
(10) Pub. No.: US 2016/0055441 A1
(43) Pub. Date: Feb. 25, 2016

(54) SYSTEMS AND METHODS TO COORDINATE RESOURCE ALLOCATION IN PROCESSING AMONG A PLURALITY OF SEPARATE COMPUTING SYSTEMS

(71) Applicant: Visa International Service Association, San Francisco, CA (US)

(72) Inventor: Douglas Joseph Rappoport, Redwood City, CA (US)

(21) Appl. No.: 14/834,920

(22) Filed: Aug. 25, 2015

Related U.S. Application Data
(60) Provisional application No. 62/041,578, filed on Aug. 25, 2014.

(51) Int. Cl. G06Q 10/06; G06F 9/50; G06Q 20/20; G06F 9/46

(52) U.S. Cl. CPC G06Q 10/06315; G06F 9/466; G06F 9/5005; G06Q 20/20

(57) ABSTRACT

A processing system having a data store storing: a first set of identifications of first terminals, a second set of identifications of second terminals, and an allocated resource. Portions of resources used in the processing of tasks requested by the first terminals are allocated as part of the allocated resource prepared for tasks requested by the second terminals. In response to a request for a task from one of the first terminals, the processing system processes communicates with a resource controller of a resource identified by the request and allocates a portion of a resource used for processing the task as part of the allocated resource. In response to a request from one of the second terminals, the processing system indicates the allocated resource to the respective terminal and processes the request using both the allocated resource and a resource identified in the request and controlled by the resource controller.

### RELATED APPLICATIONS

The present application claims priority to Prov. U.S. Pat. App. Ser. No. 62/041,578, filed Aug. 25, 2014, the entire disclosure of which is hereby incorporated herein by reference.

The present application relates to U.S. Pat. App. Pub. No. 2014/0222533, entitled “Systems and Methods to Use Transaction Authorization Communications to Process Individualized Offers,” U.S. Pat. App. Pub. No. 2013/0282461, entitled “Systems and Methods to Use Transaction Authorization Communications to Process Offers,” U.S. Pat. App. Pub. No. 2013/0246150, entitled “Systems and Methods to Apply the Benefit of Offers via a Transaction Handler,” U.S. Pat. App. Pub. No. 2013/0091000, entitled “Systems and Methods to Provide Discount at Point of Sales Terminals,” U.S. Pat. App. Pub. No. 2013/0124287, entitled “Systems and Methods to Provide Discount at Point of Sales Terminals,” and U.S. Pat. App. Pub. No. 2011/0125565, entitled “Systems and Methods for Multi-Channel Offer Redemption,” the disclosures of which applications are hereby incorporated herein by reference.

### FIELD OF THE TECHNOLOGY

At least some embodiments disclosed in the present application relate to coordination of a plurality of separate computer systems having separate resources to process a task in general and more particularly but not limited to the use of a communication system to set up the processing of a computing task initiated with a first set of terminals using a computing system that may lack a required resource hosted on a separate computer system and via the processing of one or more computing tasks initiated with a second set of terminals that involve the required resources.

### BACKGROUND

In a system having multiple computer systems connected via one or more computer networks, resources for processing a task may reside in different computer systems. The use of a predetermined communication protocol allows the computer systems to communicate with each other in a predetermined way to utilize the resources that may be distributed among the computer systems for the processing of the task. Improvements to the communication protocol can improve the performance of the system as a whole and/or improve the functionalities of the system as a whole. In some instances, improvements to the communication protocol can improve the performance of some of the individual computer systems and/or improve the functionalities of the individual computer systems.

For example, a typical electronic payment processing network has a transaction handler interconnecting a plurality of acquirer processors and a plurality of issuer processors according to an electronic communication standard. The transaction handler is generally a special purpose computer system that is substantially independent from other computer systems in the network, such as issuer processors and the acquirer processors, which are special purpose computer systems configured to control accounts from which payments are made and special purpose computer systems configured to control accounts to which the payments are made, respectively.

A typical electronic payment processing network has the capability to process certain transactions, such as credit card or debit card transactions, but may not have the capability process other transactions, such as add-on transactions (e.g., loyalty reward, benefit redemption) coupled with regular transactions.

Some recent developments provided improved electronic payment processing networks that have the improved capability to process certain add-on transactions coupled with conventional electronic payment transactions, such as those disclosed in U.S. Pat. App. Pub. No. 2014/0222533, entitled “Systems and Methods to Use Transaction Authorization Communications to Process Individualized Offers,” U.S. Pat. App. Pub. No. 2013/0282461, entitled “Systems and Methods to Use Transaction Authorization Communications to Process Offers,” U.S. Pat. App. Pub. No. 2013/0246150, entitled “Systems and Methods to Apply the Benefit of Offers via a Transaction Handler,” U.S. Pat. App. Pub. No. 2013/0091000, entitled “Systems and Methods to Provide Discount at Point of Sales Terminals,” U.S. Pat. App. Pub. No. 2013/0124287, entitled “Systems and Methods to Provide Discount at Point of Sales Terminals,” and U.S. Pat. App. Pub. No. 2011/0125565, entitled “Systems and Methods for Multi-Channel Offer Redemption,” the disclosures of which applications are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a system configured to coordinate resource allocation in processing among a plurality of separate computing systems according to one embodiment.

FIG. 2 shows a system to adjust displayed prices at point of sales devices according to one embodiment.

FIG. 3 shows a method to adjust displayed prices at point of sales devices according to one embodiment.

FIG. 4 shows a system to communicate price information according to one embodiment.

FIG. 5 shows a method to process personalized price offers according to one embodiment.

FIG. 6 illustrates a system to provide services based on transaction data according to one embodiment.

FIG. 7 shows a system to provide information based on transaction data according to one embodiment.

FIG. 8 illustrates a transaction terminal according to one embodiment.

FIG. 9 illustrates an account identifying device according to one embodiment.

FIG. 10 illustrates a data processing system according to one embodiment.

### DETAILED DESCRIPTION

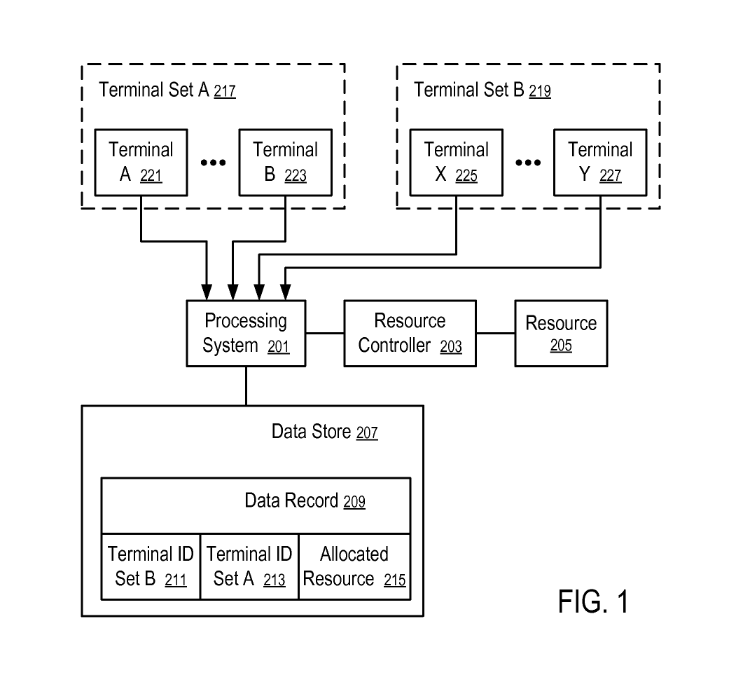

FIG. 1 shows a system configured to coordinate resource allocation in processing among a plurality of separate computing systems according to one embodiment.

In FIG. 1, the terminals (221, . . . , 223, 225, . . . , 227) are configured to initiate the processing of predetermined tasks. The terminals (221, . . . , 223, 225, . . . , 227) generate the processing parameters for the tasks and transmit the processing parameters via a communication network to the processing system (303) which processes the tasks in accordance with the parameters.

In FIG. 1, the resource controller (203) is configured to control the resource (205) for processing the tasks when the resource (205) is identified by the processing parameters transmitted from the terminals (221, . . . , 223, 225, . . . , 227).

In a typical operation, when a terminal (e.g., 221, . . . , 223, 225, . . . , or 227) initiates the processing of a predetermined task with a parameter that identifies the resource (205) controlled by the resource controller (203), the processing system (201) communicates with the resource controller (203) in accordance with the parameter that identifies the resource (205) controlled by the resource controller (203) for the processing of the task.

FIG. 1 illustrates an example of one resource controller (203) controlling one set of resources (205). In a typical application, the resource controller (203) may control a plurality of sets of resources (e.g., 205), each set of which is identified a parameter that may be used on one of the terminals (e.g., 221, . . . , 223, 225, . . . , or 227) to initiate the processing on the respective set of the resources by the processing system (201).

FIG. 1 illustrates an example of the processing system (201) coupled with one resource controller (203). In a typical application, the processing system (201) may be coupled with a plurality of resource controllers (e.g., 203), each of which controls one or more separate sets of resources (e.g., 205). A parameter used on the terminals (e.g., 221, . . . , 223, 225, . . . , or 227) to initiate the processing of a task can be configured to identify both the resource controller (203) and the resource (205).

In FIG. 1, a data store (207) coupled with the processing system (201) is configured to store a data record (209) that identifies terminal ID set A (213), terminal ID set B (211), and allocated resource (215). The data record (209) configures the processing system (201) to allocate resources (215) based on the processing of certain computing tasks for the processing of other computing tasks.

In FIG. 1, the terminal ID set A (213) identifies the terminals (221, . . . , 223) in the terminal set A (217); and the terminal ID set B (211) identifies the terminals (225, . . . , 227) in the terminal set B (219).

FIG. 1 illustrates terminals (221, . . . , 223, 225, . . . , 227) that are either in the terminal set A (217) or in the terminal set B (219). In a typical application, other terminals outside the terminal set A (217) and terminal set B (219) can also be connected to the processing system to initiate tasks processed using the resource (205) controlled by the resource controller (203).

In FIG. 1, when the processing system (201) processes a task initiated by a terminal (e.g., 221, . . . , 223, 225, . . . , or 227)) in response to a request from the terminal that identifies the terminal itself and the resource (205), the processing system (201) compares the ID of the terminal with the terminal ID set A (213) and the terminal ID set B (211).

When the ID of the terminal is in the terminal ID set A (213), the processing system (201) is configured to allocate a portion of the resource (205) used in processing the task and add the portion to the allocated resource (215) identified by the data record (209). Thus, through the processing of the tasks initiated by the terminals (221, . . . , 223) in the terminal set A (217), the allocated resource (215) increases.

In a subsequent task, when the ID of the terminal is in the terminal ID set B (213), the processing system (201) is configured to use both the allocated resource (215) and the resource (205) to process the subsequent task. Thus, even when the resource (205) along is insufficient for the processing of the task, the allocated resource (215) may cure the deficiency in the resource (205) for completing the tasks initiated on the terminal set B (219).

In one embodiment, when the allocated resource (215) is available to process a task requested by a respective terminal (e.g., 225, . . . , or 227) in the terminal set B (219), the processing system (201) further communicates with the respective terminal (e.g., 225, . . . , or 227) to indicate the availability of the allocated resource (215) and thus causes the respective terminal (e.g., 225, . . . , or 227) to adjust the processing parameters.

The technique to allocate resources for the processing of predetermined tasks as illustrated in FIG. 1 can be used, for example, to process rewards set up during the processing of payments transactions initiated via a first set of transaction terminals and processed via an electronic payment processing network, where the rewards are applied during the processing of payment transactions initiated via a second set of transaction terminals, as further discussed below.

For example, in certain loyalty programs, a coalition of first merchants may participate in a loyalty program to reward the customers for purchasing from the merchants in accordance of the loyalty program. When a user makes a purchase from one of the first merchants in the loyalty program, the merchant may use a portion of the spending of the user to provide a reward to the user. The user may accumulate rewards provided by different merchants in the loyalty program and redeem the accumulated rewards at a particular merchant, such as a gas station. For example, the redemption of such rewards can be implemented as personalized prices as described in U.S. Pat. App. Pub. No. 14/174,629, entitled “Systems and Methods to Use Transaction Authorization Communications to Process Individualized Offers”, the entire disclosure of which is hereby incorporated herein by reference.

For example, the advertising commission resulting from a user making qualified transactions from first merchants can be used to fund the price rollback for the user at a second merchant. The price rollback can be implemented as a personalized price (or a price discount).

For example, an offer network may enroll users to receive offers from first merchants (e.g., restaurants, grocery stores). During enrollment the users identify their payment accounts so that the offers are associated with the payment accounts for automated benefit redemption. The offers from the first merchants may provide discounts, incentives, rewards, or other benefits for purchases made using the registered payment accounts in accordance with the terms and conditions of the offers. The merchants pay the offer network for advertising the offers to the users, based on purchases transactions made using the registered payment accounts in accordance with the terms and conditions of the offers.

A portion of the advertisement revenue is used by a separate merchant (e.g., a gas station) to provide real time price adjustment for the respective users.

For example, the separate merchant may cooperate with an issuer to issue payment accounts that are co-branded by the merchant and the issuer. An offer can be provided to the users of such co-branded payment accounts to roll back prices for the users when the users use their payment accounts to make purchases from the merchant, in accordance with the purchases the users have made to take advantage of the offers of the offer network.

The technique discussed in connection with FIG. 1 can be applied to the processing of the offers of the offer network of the first merchants for the real time price adjustment at the second merchant. For example, the resource (205) controlled by the resource controller (203) can be used to process the funds in the payment account of the user controlled by the issuer processor of the payment account; the data record (209) tracking the allocated resource (215) can be used to track the accumulated portion of the advertisement revenue allocated to support the real time price adjustment at the transaction terminals of the second merchant; and the processing system (201) can be configured as a transaction handler of an electronic payment processing network. For example, when the funds in the payment account of the user are used to process the payment transactions initiated at the transaction terminals of the first merchants, a portion of the payments are allocated as the allocated resources (215) to support the real time price adjustment at the transaction terminals of the second merchant. When an authorization request for a transaction initiated at a transaction terminal of the second merchant is received in the transaction handler, the transaction handler checks with the data record (209) to verify the applicability of the price roll back offer to the transaction and the allocated resource (215) is sufficient for the price roll back; and if so, the transaction handler communicates with the transaction terminal of the second merchant to roll back price at the transaction terminal of the second merchant.

For example, an issuer may corporate with the second merchant (e.g., BP) to issue payment accounts co-branded with the second merchant. The offer network may corporate with the issuer and/or the merchant to enroll users of the co-branded payment accounts in the offer network. When a user of such a co-branded payment account accepts an offer from a first merchant (e.g., Panera), the offer is associated with the payment account of the user for automated redemption. For example, the offer may provides a $6 discount off a purchase, from the first merchant, that is at least $30. When the user makes a purchase of $42, the $6 discount is applied in an automated way. Thus, the user is only charged a net amount of $36, after the $6 discount. The $6 discount may be applied via a statement credit, an adjusted transaction amount during the authorization of the payment transaction.

The offer network charges the first merchant (e.g., Panera) an amount of advertisement fees based on the purchase resulting from the offer network providing the offer and fulfilling the benefit of the offer. For example, the offer network may charge the first merchant (e.g., Panera) 10% of the net purchase amount of $36 as the advertisement revenue. Thus, the first merchant (e.g., Panera) pays the offer network $3.6 for implementing the $6 discount offer from the merchant (e.g., Panera).

In one embodiment, the issuer and the co-brand merchant (e.g., BP) obtains a share of the advertisement revenue for providing the marketing access to their account holders. The co-brand merchant may use at least a portion of their share of the advertisement revenue to fund an offer to the respective account holder. For example, when co-brand merchant (e.g., BP) receives $0.6 as their share of the advertisement revenue, it can be used to support an offer of price rollback for the respective user making a purchase using the same payment account that was used to take advantage of the $6 off offer from the other merchant (e.g., Panera).

For example, the co-brand merchant (e.g., BP) offers goods (and/or services) with unit prices presented at a transaction terminal (e.g., gas pump). The offer from the co-brand merchant (e.g., BP) provides a per-unit discount (e.g., 10 cents off) funded by the purchases made to take advantage of the offers from the offer network. For example, the $0.6 advertisement revenue share allows 10 cents off price roll back up to 6 gallons of purchase from the gas pump.

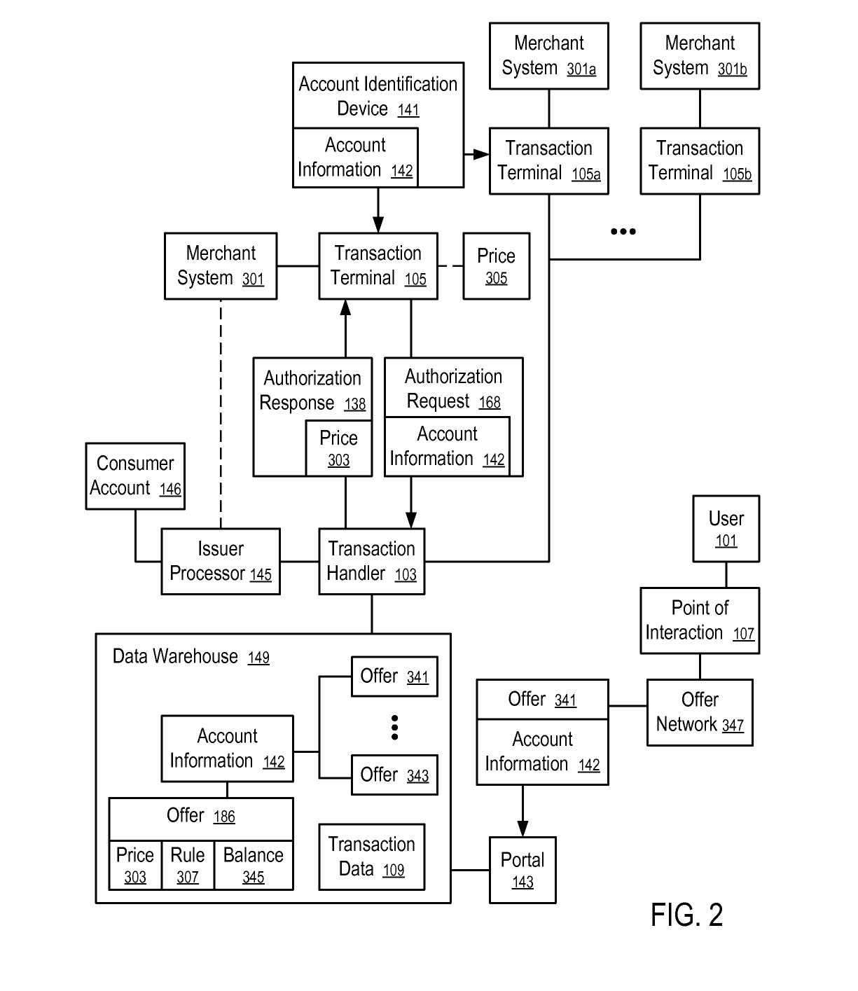

FIG. 2 shows a system to adjust displayed prices at point of sales devices according to one embodiment. In FIG. 2, the account information (142) is linked to the offer (186) from the merchant system (301) and other offers (341, . . . , 343) that are presented to the point of the interaction (107) of the user (101) of the consumer account (146) identified by the account information (142). The portal (143) is configured to receive the offer (e.g., 341) for association with the account information (142) in the data warehouse (149) for automated offer redemption.

In FIG. 2, the offer (186) is from the merchant system (301) and thus identifies the transaction terminals (e.g., 105) coupled with the merchant system (301) (e.g., as terminal set A (217)). The offers (341, . . . , 343) are associated with the merchant systems (301a . . . , 301b) and thus identify the transaction terminals (e.g., 105a, . . . , 105b) (e.g., as terminal set B (219)). The offers (341, . . . , 343) are transmitted from the offer network (347) to the point of interaction (107) of the user (101) and uploaded to the portal (143) for storage in the data warehouse (149) in association with the account information (142) that identifies the consumer account (146). The consumer account (146) hosts funds (e.g., resource (205)).

In FIG. 2, when the payment transactions initiated by the use of the account information (142) on the transaction terminals (105a, . . . , 105b) of the merchant systems (301a, . . . , 301b) are processed by the transaction handler (103) (e.g., processing system (201)), the offers (341, . . . , 343) of the respective merchant systems (301a, . . . , 301b) are checked to determine if the consumer account (146) is eligible for the benefits of the offers (341, . . . , 343).

For example, if a payment transaction initiated on the transaction terminal (105a) qualifies for the benefit of the offer (341) associated with the account information (142), the benefit of the offer (341) is provided to the consumer account (146) identified by the account information (142), e.g., via statement credit, or adjusted payment transaction.

In one embodiment, a portion of the payment qualified for the offer (341) is charged as a service fee for the operation of the offer network (347) in presenting the offer (341) to the user (101) and implementing the terms and conditions of offer (341) in providing the benefit of the offer (341) to the user (101).

In one embodiment, the merchant of the merchant system (301) is entitled to a share of the service fee (e.g., for co-branding the consumer account issued to the user (101)).

In FIG. 2, at least a portion of the share of the service fee for the merchant of the merchant system (301) is used to fund the offer (186). The data warehouse (149) tracks the balance (345) (e.g., allocated resource (215)) available to fund the offer (186) from the merchant system (301).

In one embodiment, the issuer processor (145), the portal (143), the transaction handler (103) and/or the offer network charges the merchant systems (301a, . . . , 301b) the services fees and pools the funds for supporting the offer (186) from the merchant system (301) in an account and track the balance (345) as the resource allocated for the offer (186) associated with the individual account information (142) that unique identifies the respective consumer account (146) among a plurality of consumer accounts controlled by the issuer processor (145) (e.g., resource controller (203)).

In FIG. 2, the transaction terminal (105) associated with the merchant system (301) is configured to present a price (305) (e.g., price per gallon of gas at a gas station) to the user (101). When the user (101) uses the account information (142) to initiate a pre-authorization request for purchasing from the transaction terminal, the authorization request (168) identifies the account information (142) to the transaction handler (103). If the request is approved by the issuer processor (145), the transaction handler (103) and/or the issuer (145) uses the balance of the offer (186) to determine a price (303) that is transmitted to the transaction terminal (105). The price (303) may be a price per unit (e.g., gallon) discount, a personalized/customized price, a total price discount, etc. The authorization response (138) may also include a upper limit of the quantity of the goods that can be purchased at the discounted price.

In response to the authorization response (138), the transaction terminal (105) and/or the merchant system (301) is configured to adjust the price (305) in response to the price (303) provided in the authorization response (138), before dispersing goods to the user (101) for the purchase that is authorized by the authorization response (138).

In one embodiment, a portion of the advertisement revenue generated from targeting a set of users with first discount offers for qualified purchases from a set of first merchants is used to provide a benefit to the respective users by adjusting the price at a second merchant for the respective users according to a second offer.

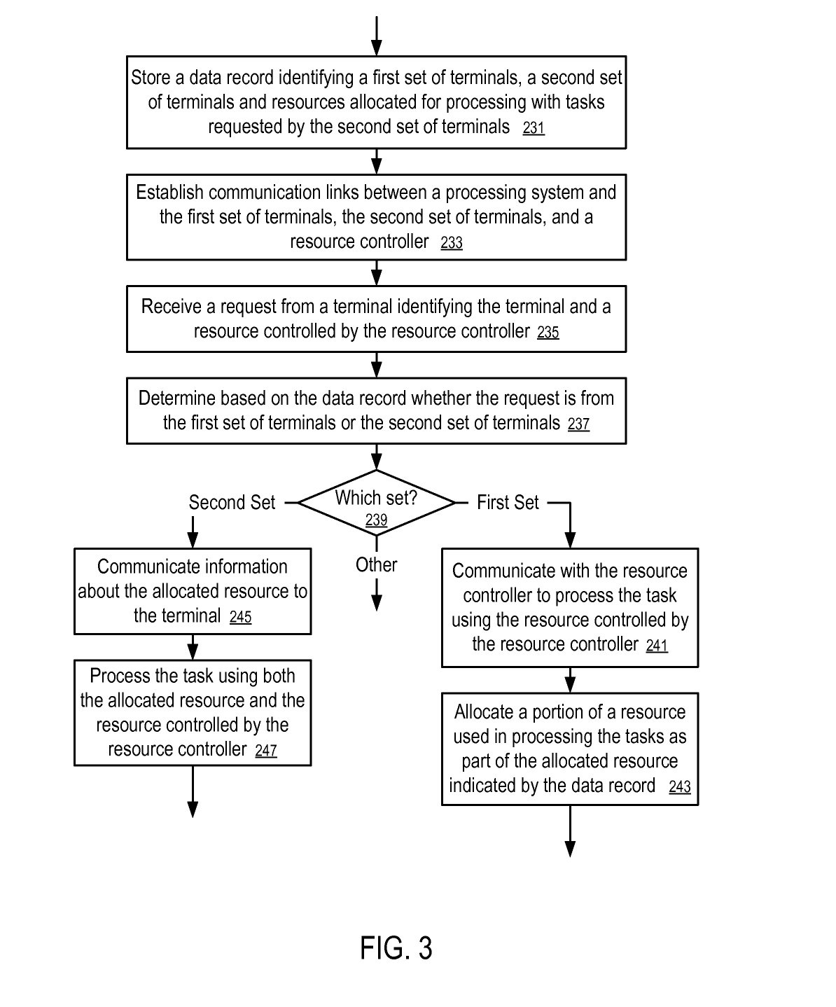

FIG. 3 shows a method to adjust displayed prices at point of sales devices according to one embodiment. For example, the method of FIG. 3 can be implemented in a system as illustrated in FIG. 1 or FIG. 2.

In FIG. 3, a computing apparatus is configured to: store (231) a data record identifying a first set of terminals, a second set of terminals and resources allocated for processing with tasks requested by the second set of terminals; establish (233) communication links between a processing system and the first set of terminals, the second set of terminals, and a resource controller; receive (235) a request from a terminal identifying the terminal and a resource controlled by the resource controller; and determine (237) based on the data record whether the request is from the first set of terminals or the second set of terminals.

If it is determined (239) that the terminal is in the first set, the computing apparatus is configured to communicate (241) with the resource controller to process the task using the resource controlled by the resource controller; and allocate (243) a portion of a resource used in processing the tasks as part of the allocated resource indicated by the data record.

If it is determined (239) that the terminal is in the second set, the computing apparatus is configured to communicate (245) information about the allocated resource to the terminal; and process (247) the task using both the allocated resource and the resource controlled by the resource controller.

For example, the computing apparatus provides a processing system (201) and a data store (207) coupled with the processing system (201), where the processing system (201) has communication links with: terminals including a first terminal set (217) and a second terminal set (219), and a resource controller (203) in control of a resource (205), as illustrated in FIG. 1.

The data store (207) stores a data record (209) including: a first terminal identification set (213) identifying the first terminal set (217) of the terminals, a second terminal identification set (211) identifying the second terminal set (219) of the terminals, and an allocated resource (215).

A request for a task to be processed at the processing system is generally generated by a respective terminal, which may be a terminal in the first terminal set (217), the second terminal set (219), or other. The request typically includes an identification of the respective terminal and identifies a resource controlled by the resource controller.

In response to the request, the processing system (201) determines whether the respective terminal is in the first terminal set (217) or the second terminal set (219) based on the first terminal identification set (213) and the second terminal identification set (211) of the data record (209).

If the respective terminal is in the first terminal set (217), the processing system (201) processes the task by communicating with the resource controller (203) to access the resource (205) controlled by the resource controller (203) and allocating a portion of a resource used for processing the task as part of the allocated resource (215).

If the respective terminal is in the second terminal set (219), the processing system (201) processes the task by communicating with the respective terminal to inform the respective terminal about the allocated resource available for the task and using both the allocated resource (215) and the resource (205) controlled by the resource controller (203).

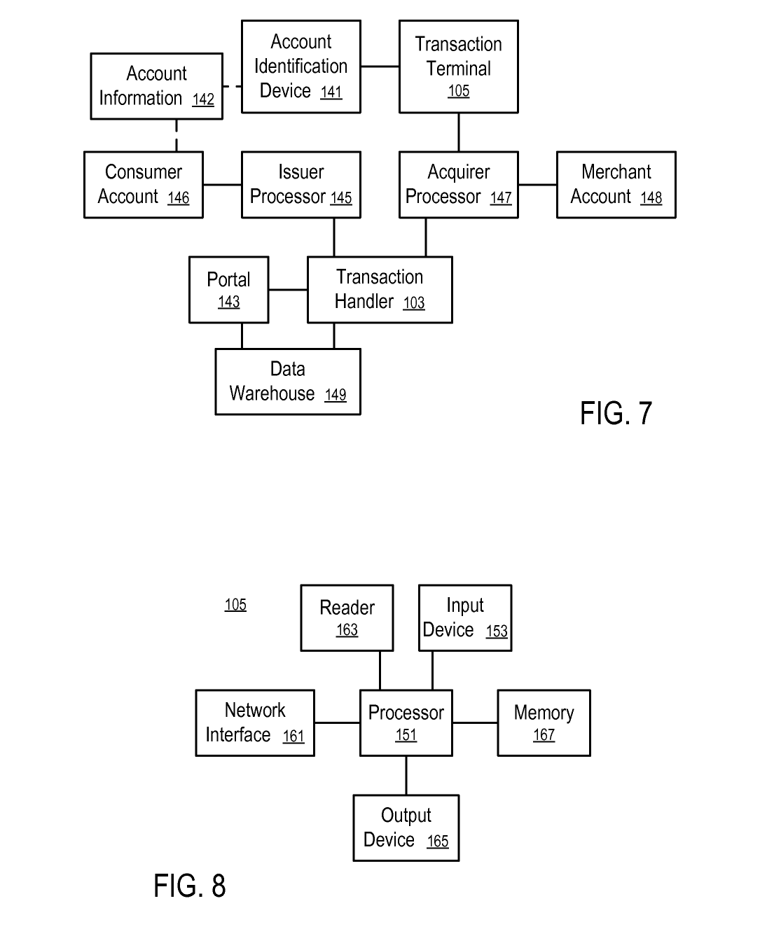

For example, the processing system (201) includes an electronic payment processing network illustrated in FIG. 7 having a transaction handler (103) interconnecting a plurality of acquirer processors (e.g., 147) and a plurality of issuer processors (e.g., 145); and the resource controller includes an issuer processor (e.g., 145) controlling a payment account (146) having funds as the resource (205) controlled by the resource controller (203).

For example, the request for the task to be processed at the processing system is in one embodiment an authorization request (168) propagated in the electronic payment processing network illustrated in FIG. 7 for a payment transaction made using the funds in the payment account (146).

If the respective terminal is in the second terminal set (219), the requested task to be processed by the processing system (201) further includes the processing system providing an authorization response (138) to the respective terminal to cause the respective terminal to roll back a price displayed at the respective terminal. The respective terminal in the second terminal set (219) includes a dispenser of goods sold at the price displayed at the respective terminal and a display device to present the price. For example, the dispenser of goods is configured to dispense fuel in one embodiment. The authorization response is provided to the respective terminal prior to the dispenser providing goods, such that the discounted price (303) computed according to the allocated resource (e.g., the balance of benefit of the offer (186)) can be displayed on the respective terminal prior to the dispensing of the goods to the purchaser.

For example, the authorization response (138) identifies a upper threshold for a quantity of goods the dispenser is authorized to dispense and/or the discounted price (303) (or the balance (345) of the benefit of the offer (186) associated with the second terminal set (219)).

If the respective terminal is in the first terminal set (217), the requested task to be processed by the processing system (201) further includes providing a discount to the payment transaction in accordance with an offer associated with the payment account (146); and a portion of the payment transaction is allocated as the part of the allocated resource (215 or 345).

In one embodiment, different users may have different individualized price deals with a merchant that have different locations. The merchant may offer the same product or service at different prices to the public at the different locations. For example, different gas stations of a franchise, a chain, or a brand may offer the same grade of gasoline at different prices. A user may be offered the same price deal applicable to these different participating gas stations publishing different prices in general. The price deal, applicable in these different participating gas stations, may include a flat price, a predetermined amount of discount per gallon, or a predetermined percentage of discount, or other types of discounts that may be dependent on the purchase frequencies, purchase amounts, transaction patterns with other merchants, the transaction profiles (e.g., 127), etc. Different users may have different types of discounts of different amounts.

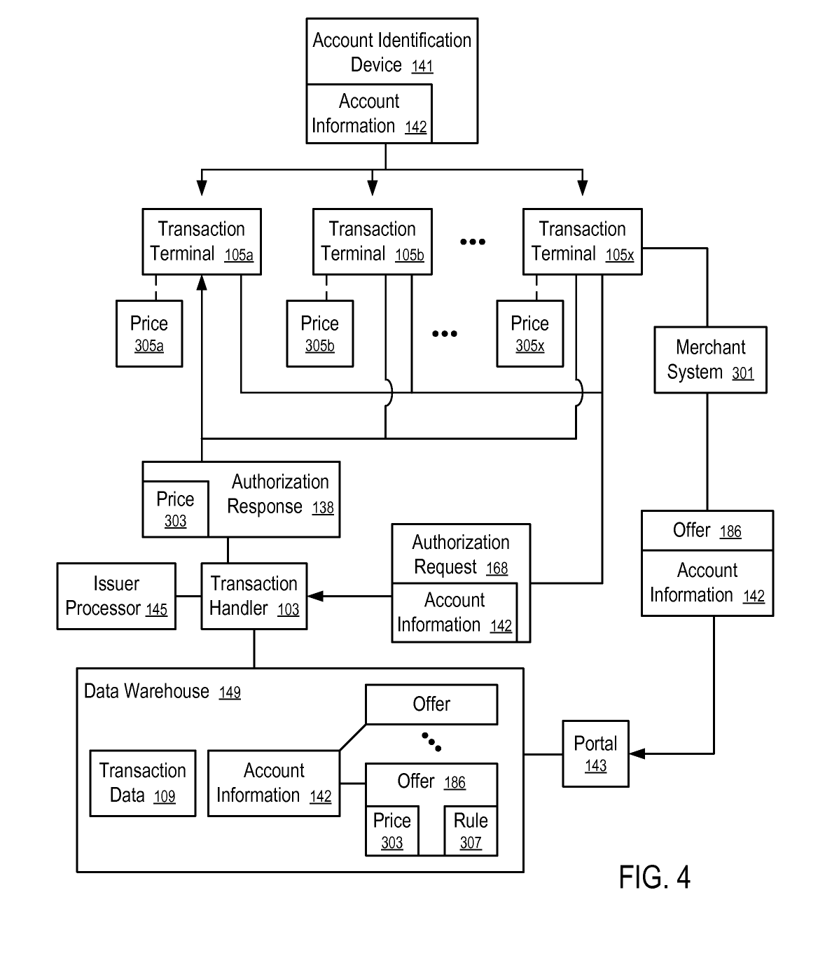

FIG. 4 shows a system to communicate price information according to according to one embodiment. In FIG. 4, a merchant system (301) associated with the transaction terminals (105a, 105b, . . . , 105x) at different locations is configured to enroll a user (101) for an offer (186) of an individualized price deal.

The user (101) may enroll in the individualized price deal through an active enrollment process, or a passive enrollment process.

For example, in an active enrollment process, the merchant system (301) may prompt the user (101) to actively enroll in a program for the individualized price deal. During the enrollment, the user (101) is prompted to provide the account information (142); and the merchant system (301) is configured to transmit the enrollment information, which associates the account information (142) with the offer (186), to a portal (143) coupled with a data warehouse (149) of a transaction handler (103) of a payment processing network. In an active enrollment process, the user (101) does not have to make a purchase using the account information (142) to make the payment to participate or enroll.

In a passive enrollment process, for example, the merchant system (301) may provide the offer (186) to the user (101) without the user (101) actively participating in the enrollment process. For example, when the merchant system (301) detected the first use of the account information (142) at the one of the transaction terminals (105a, 105b, . . . , 105x), the merchant system (301) may decide to provide an offer (186) to the user (101) without requiring the user (101) to perform an explicit action that is in addition to the conventional use of the account information (142) (e.g., to make a payment). For example, the offer (186) can be communicated to the user (101) on the receipt of the transaction that triggers the offer (186). During the transaction and prior to the presentation of the offer (186), the merchant system (301) may communicate with the portal (143) to obtain a transaction profile (127) associated with the account information (142) to facilitate the determination of whether or not to provide the offer (186) to the use and/or the customization of the offer (186) for the user (101). The merchant system (301) is configured to transmit the enrollment information to the portal (143) for association between the account information (142) and the offer (186), such that the offer (186) can be applied to subsequent qualified purchases in ways as discussed in the present application.

In FIG. 4, after the merchant system (301) communicates to the portal (143) data associating the account information (142) with the offer (186), the data warehouse (149) stores the data associating the account information (142) with the offer (186). The offer (186) may include the individualized price (303) and one or more rules (307) that specify the conditions for applying the individualized price (303). Based on the one or more rules (307) and the account information (142), the portal (143) may generate a trigger record for the transaction handler (103) to detect a transaction that partially satisfy the conditions for applying the individualized price (303) and, when a transaction satisfies the conditions specified in the trigger record, the trigger record directs the transaction handler (103) to determine the applicability of the offer (186).

In FIG. 4, after the offer (186) is associated with the data warehouse (149), the user (101) may use the account identification device (141), configured to present the account information (142) to a transaction terminal (e.g., 105a, 105b, . . . , or 105x) to initiate a payment transaction, to make payment transactions and receive the benefit of the price (303) identified in the offer (186) for eligible payment transactions.

For example, in one embodiment, before the user (101) making a purchase at a transaction terminal (e.g., 105a, 105b, . . . , or 105x) of the merchant, the account identification device (141) is used to initiate a pre-authorization request (168). For example, before the user (101) is allowed to pump gas at a fuel dispense station, the user (101) may use the account identification device (141) to initial authorization. The authorization request (168) identifies the account information (142) to reserve funds for the purchase. The authorization request (168) in FIG. 4 may identify an upper limit for the transaction and thus cause issuer processor (145) to reserve, according to the upper limit, funds or credits in the consumer account (146) identified by the account information (142) for the purchase. Alternatively, the authorization request (168) may identify a predetermined amount (e.g., $1.00) for the pre-authorization; and the issuer processor (145) may determine whether or not to authorize the transaction based on a transaction history, a typically purchase upper limit, and/or a predetermined upper limit for such transactions.

In FIG. 4, different transaction terminals (105a, 105b, . . . , 105x) associated with different retail locations may have different published prices (305a, 305b, . . . , 305x) for the same product or service that the user may purchase. When the benefit of the offer (186) is not applied to the purchase, the purchase amount is based on the published price (e.g., 305a, 305b, . . . , or 305x) associated with the respective transaction terminal (e.g., 105a, 105b, . . . , or 105x) on which the pre-authorization is made.

In FIG. 4, when the transaction handler (103) determines that the offer (186) is applicable to the authorization request (168) initiated during pre-authorization, the transaction handler (103) is configured to provide the price (303) to the transaction terminal (e.g., 105a, 105b, . . . , or 105x) via the authorization response (138). The transaction terminals (105a, 105b, . . . , and 105x) are configured to retrieve the price (303) from the authorization response (138) and present and use the price (303) on the transaction terminal (105a, 105b, . . . , and 105x), instead of the published the prices (105a, 105b, . . . , and 105x). Thus, regardless of the transaction terminal (e.g., 105a, 105b, . . . , or 105x) used for the purchase, the user (101) is provided with the benefit of the same price (303) identified in the offer (186), when the offer (186) is applicable according to the rule (307).

In FIG. 4, after the transaction terminal (e.g., 105a, 105b, . . . , or 105x) replaces the published price (e.g., 305a, 305b, . . . , or 305x) with the individualized price (303) transmitted via the authorization response (138) for the purchase corresponding to the pre-authorization initiated using the account identification device (141), the respective transaction terminal (e.g., 105a, 105b, . . . , or 105x) is configured to present the individualized price (303) to the user (101) during the transaction and uses the individualized price (303) to compute the transaction amount for the purchase made by the user (101). After the purchase, the respective transaction terminal (e.g., 105a, 105b, . . . , or 105x) is configured to transmit a settlement request to the transaction handler (103), via the acquirer processor (147) in a way as illustrated in FIG. 7. The settlement request identifies the transaction amount based on the individualized price (303) received in the authorization response (138). The transaction handler communicates with the issuer processor (145) and the acquirer processor (147) to settle the transaction, in a way as illustrated in FIG. 7.

FIG. 4 illustrates an example of an offer (186) of a flat price (303). The system of FIG. 4 can be modified to provide the benefit of other types of price benefits. For example, the benefit of the offer (186) can be constructed to be the lower one of the published price (e.g., 305a, 305b, . . . , or 305x) at the respective transaction terminal (e.g., 105a, 105b, . . . , or 105x) and the predetermine price (303). For example, the benefit of the offer (186) can be constructed to be a predetermined amount of discount over the published price (e.g., 305a, 305b, . . . , or 305x), such as 10 cents off the published per gallon price at a respective gas station. For example, the benefit of the offer (186) can be constructed to be a predetermined amount of discount off a transaction above a threshold, such as $1 off a purchase of more than 5 gallons of gasoline. For example, the benefit of the offer (186) can be constructed to be a predetermined percentage off the published per gallon price at a respective gas station.

In FIG. 4, the transaction terminals (e.g., 105a, 105b, . . . , and 105x) are configured to present the price (e.g., 303) as adjusted according to the offer (186), before the user purchases or checks out of the items or services purchased (e.g., before the user using the gas pump to obtain fuel).

In one embodiment, the data warehouse (149) in FIG. 4 is further configured to store a communication reference (611) associated with the account information (142). When the offer (186) is applicable to the authorization request (168), the portal (149) is configured to provide a notification to the user (101) at the communication reference (611) during the processing of the pre-authorization. Further, when the offer (186) is associated with the account information (142) in the data warehouse (149), the portal (149) may optionally be configured to provide a notification to the user (101) at the communication reference (611) (e.g., based on preference setting of the user (101)).

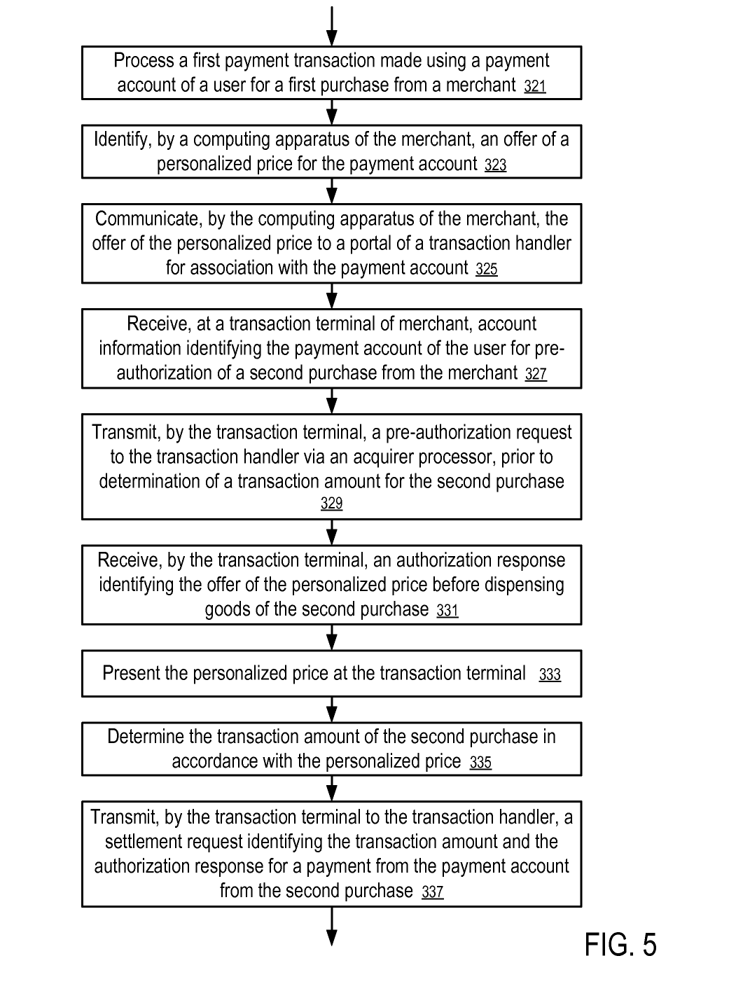

FIG. 5 shows a method to process personalized price offers according to one embodiment. In one embodiment, the method of FIG. 5 is implemented in a system illustrated in FIG. 4.

In FIG. 5, after the processing (321) of a first payment transaction made using a payment account (e.g., the consumer account (146) illustrated in FIG. 7) of a user (101) for a first purchase from a merchant, a computing apparatus (e.g., the merchant system (301) illustrated in FIG. 4) of the merchant identifies (323) an offer (186) of a personalized price (303) for the payment account, and communicates (325) the offer (186) of the personalized price (303) to a portal (143) of a transaction handler (103) for association with the payment account that is identified by account information (142).

Subsequently, when a transaction terminal (e.g., 105a, 105b, or 105x) of merchant receives (327) the account information (142) identifying the payment account of the user (101) for pre-authorization of a second purchase from the merchant, the transaction terminal (e.g., 105a, 105b, or 105x) transmits (329), prior to determination of a transaction amount for the second purchase, a pre-authorization request (168) to the transaction handler (103) via an acquirer processor (147) for authorization by the issuer processor (145) of the payment account of the user (101), receives (331) an authorization response (138) identifying the offer (186) of the personalized price (303) before dispensing goods (e.g., fuel) of the second purchase, and presents (333) the personalized price (303) at the transaction terminal (e.g., 105a, 105b, or 105x).

After determining (335) the transaction amount of the second purchase, in accordance with the personalized price (303) and an amount of the dispensed goods (e.g., fuel), the transaction terminal (e.g., 105a, 105b, or 105x) transmits (337) to the transaction handler (103) a settlement request identifying the transaction amount and the authorization response (138), for a payment from the payment account for the second purchase.

In one embodiment, a transaction terminal (e.g., 105a, 105b, or 105x) connected to a merchant system (301) is configured to receive account information (142) that identifies a consumer account (146) for a payment transaction. In response to the account information (142) received from an account identification device (141) of the user (101), the transaction terminal (e.g., 105a, 105b, or 105x) generates an authorization request (168) for transmission to an acquirer processor (147) of the merchant, the transaction handler (103) of the payment processing network, and the issuer processor (145) of the consumer account (146).

The authorization request (168) includes the account information (142) that identifies the consumer account (146). When the transaction handler (103) detects that the authorization request (168) is for the account information (142) associated with the offer (186) of the personalized price (303), the transaction handler (103) is configured to identify the price (303) in the authorization response (138) that corresponds to the authorization request (168).

After the transaction terminal (e.g., 105a, 105b, or 105x) receives the authorization response (138) from the acquirer processor for the authorization request (168), the transaction terminal (e.g., 105a, 105b, or 105x) temporarily adjusts a published price (e.g. 305a, 305b, or 305x) at the transaction terminal (e.g., 105a, 105b, or 105x) according to the price information (e.g., 303) that is provided in the authorization response (138).

In the embodiment, the authorization request (168) is for pre-authorization of a sale of goods or services the amount of which has not yet been determined. Since the amount of goods or services to be purchased has not yet been determined, a transaction amount cannot be computed at the time of the authorization request (168); and the authorization request (168) may identify an upper limit for the transaction amount to be authorized, or a nominal amount (e.g., $1) which will be replaced by the actual transaction amount in the settlement request for the transaction.

The transaction terminal (e.g., 105a, 105b, or 105x) may replace the display of the published price (e.g. 305a, 305b, or 305x) with the individualized price (303) provisioned by the offer (186) for the duration of the purchase authorized by the authorization response (138) associated with the account information (142). The change in the display of the price on the transaction terminal (e.g., 105a, 105b, or 105x) communicates to the user (101) that the offer (186) is being applied to the current purchase (e.g., before the user receiving the dispensed goods, such as fuel, at the transaction terminal).

After the amount of goods or services being purchase is determined (e.g., after the user finishing receiving fuels in a vehicle), the transaction terminal determines, a transaction amount for the payment transaction based on the individualized price (303) and transmits a settlement request for the payment transaction. The settlement request identifies the transaction amount computed according to the individualized price (303).

In one embodiment, the authorization response (138) is configured to specify price information provisioned by the offer (186). The price information may include the individualized price (303) predetermined for the offer (186) provided to the consumer account (146).

In some embodiments, the individualized price to be displayed on the transaction terminal is calculated based on the price information and the published price (305). For example, the individualized price may be calculated as a smaller one of: a predetermined price identified in the price information, and the published price (e.g., 305a, 305b, or 305x), or based on a predetermined discount off the published price (e.g., 305a, 305b, or 305x).

In one embodiment, the offer (186) is provided to the user (101) in response to a prior payment transaction made using the account information (142) identifying the consumer account (146), before the authorization request (168) for the current purchase.

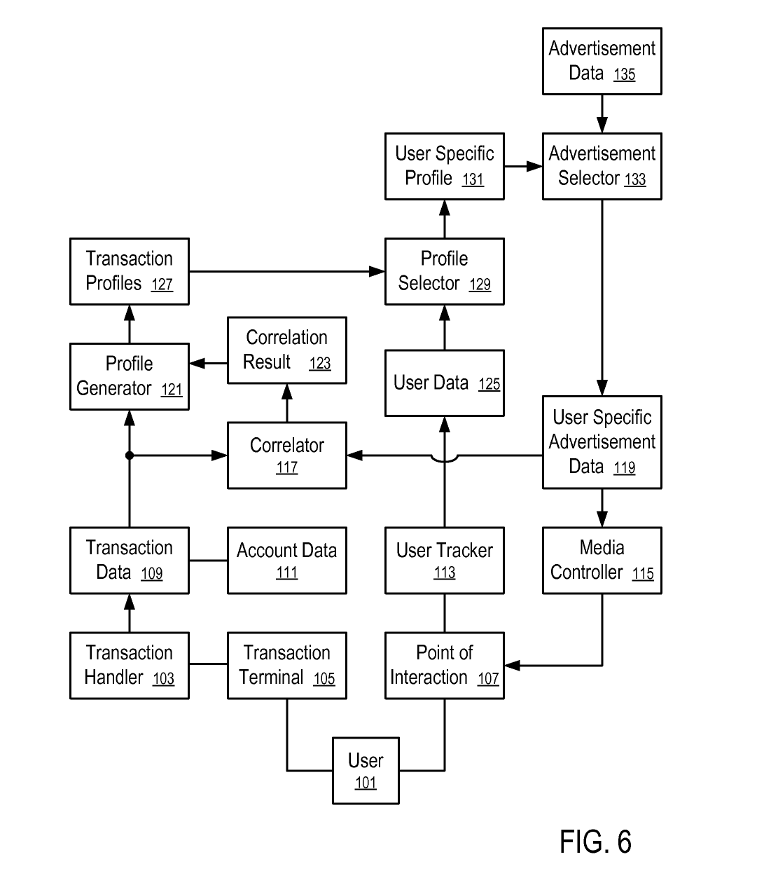

For example, the merchant system is configured in one embodiment to communicate with a portal (143) coupled with a data warehouse (149) that is configured to store transaction data (109) recording transactions processed at the transaction handler (103) and configured to store transaction profiles (127) (illustrated in FIG. 6) generated from the transaction data (109). The merchant system is configured to communicate with a portal (143) to access a user specific transaction profile (131) associated with the account information (142) in response to the prior payment transaction and based at least in part on the user specific transaction profile (131) to make a determination to provide the offer (186) to the user (101).

In one embodiment, the merchant system (301) is configured to provide the offer (186) to the user (101), in response to the prior payment transaction made using the account information (142) and before the authorization request (168) for the current purchase. Since the offer (168) is made in connection with the prior payment transaction made using the account information (142), the user (101) does not have to actively provide enrollment information, such as the account information (142).

The offer (186) may be provided to the user (101) in an active mode that requires the user (101) to provide enrollment input after the prior payment transaction, or in a passive mode that does not require the user (101) to provide additional input.

In the passive mode, the merchant system (301) is configured to communicate with the portal (143) to associate the offer (186) with the consumer account in response to the prior payment transaction, without receiving separate information from the user (101) of the consumer account (142).

In the active mode, the computing system is configured to communicate with the user (101) of the consumer account to receive enrollment information from the user for enrolling the user in the offer (186) hosted on the data warehouse (149) of the transaction handler (103). The enrollment information may include the communication reference (611) for association with the account information (142) in the data warehouse (149).

For example, after the offer (186) is associated with the account information (142) in the data warehouse (149), the portal (143) and/or the merchant system (301) may provide a notification about the offer (186) to the communication reference associated with the account information (142), in the active mode and/or the passive mode.

For example, the merchant system (301) may communicate with the portal (143) to access a transaction profile associated with the account information (142) in response to the prior payment transaction, where the portal (143) is coupled with the data warehouse (149) configured to: store transaction data (109) recording transactions processed at the transaction handler, and store transaction profiles (127) generated from the transaction data (109). The transaction profile is used in determining whether or not to provide the offer (186) to the user (101).

In one embodiment, the transaction terminal (e.g., 105a, 105b, or 105x) is configured to permit, based on the individualized price, dispensing an amount of goods (e.g., fuel) for purchasing via the payment transaction authorized by the authorization response (138). For example, the permitted amount to be dispensed at the transaction terminal can be computed based on an upper limit via the authorization request (168) and the unit price (303) identified by the authorization response (138). The upper limit may be identified in the authorization request (168), or predetermined when a nominal amount (e.g., $1) is specified in the authorization request (168).

In one embodiment, the transaction terminal (e.g., 105a, 105b, or 105x) includes a fuel pump for dispensing fuel to be purchased by the user (101).

In one embodiment, a non-transitory computer-storage medium is configured to store instructions configured to instruct a computing apparatus to perform at least the operations discussed above, such as adjusting the published price (e.g., 305a, 305b, or 305x) at a transaction terminal (e.g., 105a, 105b, or 105x), according to the price information provided in the authorization response (138), to present to the user (101) an individualized price (303) for the user (101).

In one embodiment, a computing apparatus includes at least one microprocessor (173), and a memory (167) storing instructions configured to instruct the at least one processor to at least some of the operations discussed above, such as presenting to the user (101) an individualized price for the user (101) by temporarily replacing a published price at a transaction terminal (e.g., 105a, 105b, or 105x) with the individualized price (303) computed according to the price information received in the authorization response (138).

### Further Applications

In one embodiment, a transaction handler is configured to determine whether a transaction in a payment account, as identified in an authorization request, received from an acquirer processor for the transaction, is eligible for the benefit of an offer associated with the payment account, and if so, split the transaction originally requested in the payment account into two or more transactions with an issuer processor of the payment account and one or more sponsor processors of the offer to apply the benefit of the offer to the authorization request for the transaction requested. The two or more transactions are combined for the transaction terminal of the merchant and/or the acquirer processor, such that the details of the two or more transactions are insulated from the transaction terminal and/or the acquirer processor. Thus, a conventional transaction terminal and/or a conventional acquirer processor can be used in the system configured to apply the benefit of an offer during the processing of a transaction initiated and completed at the transaction terminal. Further details and examples can be found in U.S. Pat. App. Pub. No. 2013/0246150, entitled “Systems and Methods to Apply the Benefit of Offers via a Transaction Handler,” the entire disclosure of which is hereby incorporated herein by reference.

To facilitate offer redemption via the split-transaction technique as identified above, data associating offers with account information identifying the consumer accounts or payment accounts of the users can be stored in a data warehouse coupled with the transaction handler. For example, in one embodiment of associating offers with consumer/payment accounts, a portal of the transaction handler is configured to store data representing offers, and to associate user selected offers with the financial accounts of the respective users, if the users select advertisements containing the offers. When the financial accounts are used to make payments processed by the transaction handler for purchases that satisfy the respective redemption conditions of the offers, the transaction handler and/or the portal are configured to detect such payment transactions and fulfill the offers in an automated way, such as in the embodiment of the split-transaction identified above.

For example, the advertisement providing the offer can be configured to have multiple selectable regions when the advertisement is presented in a web browser of a user. Examples of offers include discounts, incentives, rebates, coupons, rewards, cash back, etc. One of the selectable-regions contains a Uniform Resource Locator (URL) of the advertiser or merchant, which, when selected, directs the user to the website of the advertiser or merchant. A separate one of the selectable regions contains a Uniform Resource Locator (URL) of the portal of the transaction handler, which, when selected, directs the user to the portal for access to a user interface to register the offer with a financial account of the user. Examples of financial accounts of users include credit card accounts, debit card accounts, prepaid card accounts, bank accounts, etc. Some details and examples about associating offers with financial accounts can be found in U.S. Pat. App. Pub. No. 2011/0125565, entitled “Systems and Methods for Multi-Channel Offer Redemption,” the entire disclosure of which is hereby incorporated herein by reference.

After the offer is associated with the financial account of the user, the transaction handler and/or the portal are configured to detect that the user is making a payment using the financial account for a purchase that satisfies the redemption requirements of the offer. In response to the detection, the portal may optionally notify the user of the eligibility of the redemption of the offer using a communication reference associated with the financial account, and the transaction handler and/or the portal are configured to automate the processing of the offer for redemption, such as using the split-payment embodiment identified above, or via statement credits to the financial account of the user, or via benefits afforded via a loyalty program, such as reward points, loyalty points, etc.

When an offer is sponsored by the merchant, the transaction handler can be configured in one embodiment to apply the benefit of the registered offer during the authorization and/or settlement of the transaction that meets the requirement for the redemption of the offer via modifying the transaction amount. For example, the authorization amount can be changed by the transaction handler to provide the benefit of the registered offer during the authorization phase of the transaction in one embodiment, and the settlement amount can be changed by the transaction handler to provide the benefit of the registered offer during the settlement phase of the transaction in another embodiment. Some details and examples about redeeming offer benefits via modifying transaction amounts can be found in U.S. Pat. App. Pub. No. 2013/0091000, entitled “Systems and Methods to Provide Discount at Point of Sales Terminals,” and U.S. Pat. App. Pub. No. 2013/0124287, entitled “Systems and Methods to Provide Discount at Point of Sales Terminals,” the entire disclosures of which applications are hereby incorporated herein by reference.

In one embodiment, a transaction terminal is configured to submit two successive authorization requests for a payment transaction. A first authorization request identifies a consumer account in which the payment transaction is to occur, and a transaction handler is configured to provide an authorization response that identifies offer information relevant to the payment transaction. A subsequent second authorization request is generated based at least in part on the offer information, and the transaction handler is configured to communicate with an issuer processor of the consumer account in accordance with the second authorization request. For example, when the offer information identifies a benefit of an offer applicable to the transaction, the transaction terminal is configured to adjust the transaction amount according to the benefit of the offer. For example, when the offer information identifies an offer to the user of the consumer account, the transaction terminal is configured to present the offer to the user, receive a mobile phone number from the user, and transmit the mobile phone number to the transaction handler in the second authorization request to allow a portal of the transaction handler to provide further information to the user about the offer. For example, when the offer information identifies loyalty points available in a loyalty program associated with the consumer account, the transaction terminal is configured to prompt the user to selectively redeem a portion of the available loyalty points for the payment transaction and communicate the loyalty point redemption request to the transaction handler in the second authorization request. Further details and examples in one embodiment can be found in U.S. Pat. App. Pub. No. 2013/0282461, entitled “Systems and Methods to Use Transaction Authorization Communications to Process Offers,” the entire disclosures of which applications are hereby incorporated herein by reference.

In one embodiment, a merchant can offer an individualized price offer to a user. The individualized price offer is associated with the account information of a financial payment account of the user. When the financial payment account of the user is used to pre-authorize for a purchase, data identifying the applicable price offer is communicated to the transaction terminal in the pre-authorization response, which causes the transaction terminal to adjust and present the individualized price for the user before the user makes the purchase. After the user makes the purchase, the transaction terminal is configured to compute the transaction amount according to the individualized price for the user and requests the settlement of the computed transaction amount in the financial payment account of the user. Further details and examples in one embodiment can be found in U.S. Pat. App. Pub. No. 2014/0222533, entitled “Systems and Methods to Use Transaction Authorization Communications to Process Individualized Offers,” the entire disclosures of which applications are hereby incorporated herein by reference.

Since the transaction handler records the transaction data for transactions made in various purchase channels, such as online marketplaces, offline in retail stores, phone orders, etc., the registered offer can be redeemed in an automated way, without being limited by the channel used to make the purchase and limited by the context of the purchase. Thus, the system provides a normalized, real-time, online and offline, redemption service for offers in combination with, and integrated with, the processing of payment transactions.

The transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

### Transaction Data Based Services

FIG. 6 illustrates a system to provide services based on transaction data according to one embodiment. In FIG. 6, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 6, the system further includes a correlator (117) to correlate user specific advertisement data (119) with transactions resulting from the user specific advertisement data (119). The correlation results (123) can be used by the profile generator (121) to improve the transaction profiles (127).

The transaction profiles (127) of one embodiment are generated from the transaction data (109) in a way as aggregated spending profile illustrated in U.S. Pat. App. Pub. No. 2010/0306029, entitled “Cardholder Clusters,” and U.S. Pat. App. Pub. No. 2010/0306032, entitled “Systems and Methods to Summarize Transaction Data,” the disclosures of which applications are hereby incorporated herein by reference.

In one embodiment, a data warehouse (149) as illustrated in FIG. 7 is coupled with the transaction handler (103) to store the transaction data (109) and other data, such as account data (111), transaction profiles (127) and correlation results (123). In FIG. 7, a portal (143) is coupled with the data warehouse (149) to provide data or information derived from the transaction data (109), in response to a query request from a third party or as an alert or notification message.

In FIG. 7, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

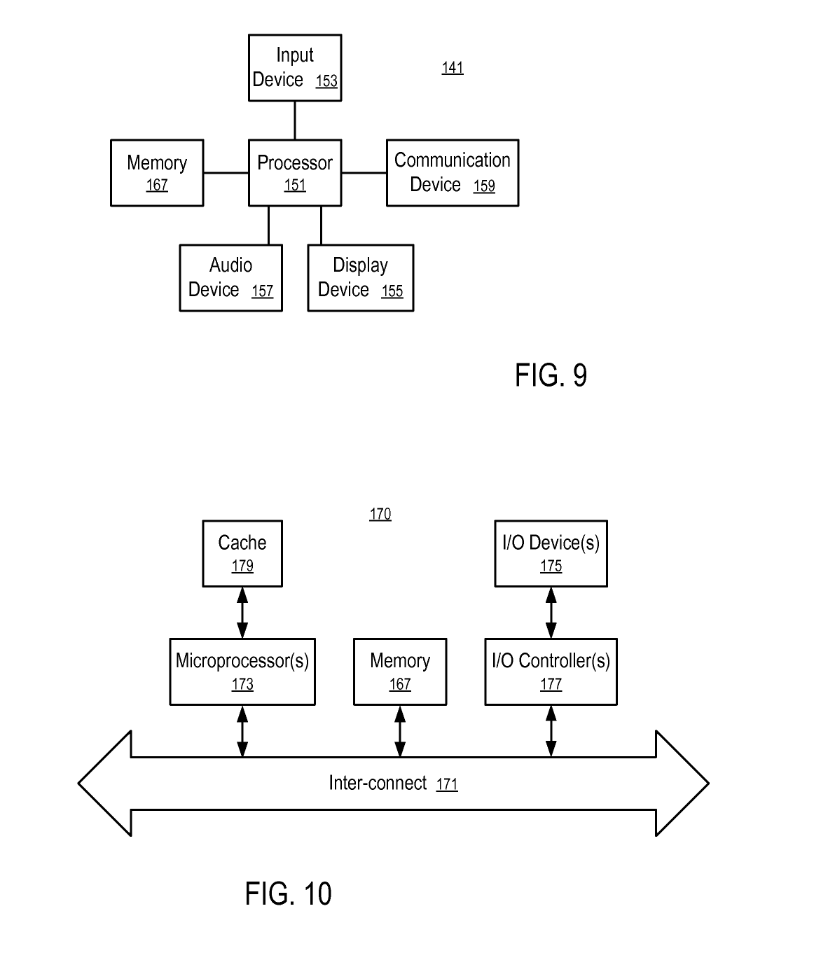

FIGS. 8 and 9 illustrate examples of transaction terminals (105) and account identification devices (141). FIG. 10 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 6-10, and other figures.

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 6, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment can be found in U.S. Pat. App. Pub. No. 2010/0306029, entitled “Cardholder Clusters,” and U.S. Pat. App. Pub. No. 2010/0306032, entitled “Systems and Methods to Summarize Transaction Data,” the disclosures of which applications are hereby incorporated herein by reference.

### Transaction Processing and Data

FIG. 7 shows a system to provide information and/or services based on transaction data (109) according to one embodiment.

In FIG. 7, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records, such as the transaction profiles (127), aggregated spending profile, offer redemption notification, etc. The portal (143) may be implemented as a web portal, a telephone gateway, a file/data server, etc.

In FIG. 7, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 7, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 7, the transaction handler (103) uses the data warehouse (149) to store the records about the transactions, such as the transaction records or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 7, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 7, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

### Transaction Terminal

FIG. 8 illustrates a transaction terminal according to one embodiment. The transaction terminal (105) illustrated in FIG. 8 can be used in various systems discussed in connection with other figures of the present disclosure. In FIG. 8, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 8. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 8. For example, in one embodiment, the transaction terminal (105) is an ATM machine, which includes components to dispense cash under certain conditions.

### Account Identification Device

FIG. 9 illustrates an account identifying device according to one embodiment. In FIG. 9, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 9, such as a cellular communications subsystem.

In one embodiment, the communication device (159) may access the account information (142) stored on the memory (167) without going through the processor (151).

In one embodiment, the account identification device (141) has fewer components than those illustrated in FIG. 9. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 10, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 10. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 10, with more or fewer components.

In one embodiment, the transaction handler (103) is a payment processing system, or a payment card processor, such as a card processor for credit cards, debit cards, etc.

FIG. 10 illustrates a data processing system according to one embodiment. While FIG. 10 illustrates various components of a computer system, it is not intended to represent any particular architecture or manner of interconnecting the components. One embodiment may use other systems that have fewer or more components than those shown in FIG. 10.

In FIG. 10, the data processing system (170) includes an inter-connect (171) (e.g., bus and system core logic), which interconnects a microprocessor(s) (173) and memory (167). The microprocessor (173) is coupled to cache memory (179) in the example of FIG. 10.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
providing a processing system and a data store coupled with the processing system, wherein the processing system has communication links with terminals including a first terminal set and a second terminal set, and a resource controller in control of a resource;
storing in the data store a data record including
a first terminal identification set identifying the first terminal set of the terminals,
a second terminal identification set identifying the second terminal set of the terminals, and
an allocated resource;
in response to a request for a task to be processed at the processing system wherein the request includes an identification of a respective terminal and identifies a resource controlled by the resource controller, determining whether the respective terminal is in the first terminal set or the second terminal set based on the first terminal identification set and the second terminal identification set of the data record;
if the respective terminal is in the first terminal set, processing the task by the processing system communicating with the resource controller to access the resource controlled by the resource controller and allocating a portion of a resource used for processing the task as part of the allocated resource; and
if the respective terminal is in the second terminal set, processing the task by the processing system communicating with the respective terminal to inform the respective terminal about the allocated resource available for the task.

2. The method of claim 1, wherein if the respective terminal is in the second terminal set, the task is processed using the resource controlled by the resource controller and the allocated resource.

3. The method of claim 2, wherein the processing system includes an electronic payment processing network having a transaction handler interconnecting a plurality of acquirer processors and a plurality of issuer processors.

4. The method of claim 3, wherein the resource controller includes an issuer processor controlling a payment account having funds as the resource controlled by the resource controller.

5. The method of claim 4, wherein the request for the task to be processed at the processing system includes an authorization request propagated in the electronic payment processing network for a payment transaction made using the funds in the payment account.

6. The method of claim 5, wherein if the respective terminal is in the second terminal set, the task further includes the processing system providing an authorization response to the respective terminal to cause the respective terminal to roll back a price displayed at the respective terminal.

7. The method of claim 6, wherein if the respective terminal is in the second terminal set, the respective terminal further includes a dispenser of goods sold at the price displayed at the respective terminal.

8. The method of claim 7, wherein the dispenser of goods is configured to dispense fuel.

9. The method of claim 7, wherein the authorization response is provided to the respective terminal prior to the dispenser providing goods.

10. The method of claim 7, wherein the authorization response identifies a upper threshold for a quantity of goods the dispenser is authorized to dispense.

11. The method of claim 5, wherein if the respective terminal is in the first terminal set, the task further includes providing a discount to the payment transaction in accordance with an offer associated with the payment account; and a portion of the payment transaction is allocated as the part of the allocated resource.

12. A non-transitory computer-storage medium storing instructions configured to instruct a computing apparatus to perform a method, the method comprising:
storing a data record in a data store coupled with a processing system having communication links with
terminals including a first terminal set and a second terminal set, and
a resource controller in control of a resource, wherein the data record includes
a first terminal identification set identifying the first terminal set of the terminals,
a second terminal identification set identifying the second terminal set of the terminals, and
an allocated resource;
in response to a request for a task to be processed at the processing system wherein the request includes an identification of a respective terminal and identifies a resource controlled by the resource controller, determining whether the respective terminal is in the first terminal set or the second terminal set based on the first terminal identification set and the second terminal identification set of the data record;
in response to a determination that the respective terminal is in the first terminal set, processing the task by the processing system communicating with the resource controller to access the resource controlled by the resource controller and allocating a portion of a resource used for processing the task as part of the allocated resource; and
in response to a determination that the respective terminal is in the second terminal set, processing the task by the processing system communicating with the respective terminal to inform the respective terminal about the allocated resource available for the task.

13. The computer-storage medium of claim 12, wherein when the respective terminal is in the second terminal set, the task is processed using the resource controlled by the resource controller and the allocated resource.

14. The computer-storage medium of claim 13, wherein the processing system includes an electronic payment processing network having a transaction handler interconnecting a plurality of acquirer processors and a plurality of issuer processors; the resource controller includes an issuer processor controlling a payment account having funds as the resource controlled by the resource controller; and the request for the task to be processed at the processing system includes an authorization request propagated in the electronic payment processing network for a payment transaction made using the funds in the payment account.

15. The computer-storage medium of claim 14, wherein if the respective terminal is in the first terminal set, the task further includes providing a discount to the payment transaction in accordance with an offer associated with the payment account; and a portion of the payment transaction is allocated as the part of the allocated resource.

16. The computer-storage medium of claim 12, wherein when the respective terminal is in the second terminal set, the task further includes the processing system providing an authorization response to the respective terminal to cause the respective terminal to roll back a price displayed at the respective terminal; and the respective terminal further includes a dispenser of goods sold at the price displayed at the respective terminal.

17. The computer-storage medium of claim 16, wherein the dispenser of goods is configured to dispense fuel; and the authorization response is provided to the respective terminal prior to the dispenser providing goods.

18. The computer-storage medium of claim 16, wherein the authorization response identifies a upper threshold for a quantity of goods the dispenser is authorized to dispense.

19. A computing apparatus, comprising:
at least one network interface;
at least one microprocessor, and
a memory storing instructions configured to instruct the at least one microprocessor and the at least one network interface to perform operations including:
providing a processing system and a data store coupled with the processing system, wherein the processing system has communication links over the at least one network interface with terminals including a first terminal set and a second terminal set, and
a resource controller in control of a resource;
storing in the data store a data record including
a first terminal identification set identifying the first terminal set of the terminals,
a second terminal identification set identifying the second terminal set of the terminals, and
an allocated resource;
in response to a request for a task to be processed at the processing system wherein the request includes an identification of a respective terminal and identifies a resource controlled by the resource controller, determining whether the respective terminal is in the first terminal set or the second terminal set based on the first terminal identification set and the second terminal identification set of the data record;
if the respective terminal is in the first terminal set, processing the task by the processing system communicating with the resource controller to access the resource controlled by the resource controller and allocating a portion of a resource used for processing the task as part of the allocated resource; and
if the respective terminal is in the second terminal set, processing the task by the processing system communicating with the respective terminal to inform the respective terminal about the allocated resource available for the task.

20. The computing apparatus of claim 19, wherein the processing system includes an electronic payment processing network having a transaction handler interconnecting a plurality of acquirer processors and a plurality of issuer processors; the resource controller includes an issuer processor controlling a payment account having funds as the resource controlled by the resource controller; and the request for the task to be processed at the processing system includes an authorization request propagated in the electronic payment processing network for a payment transaction made using the funds in the payment account.
